(19) United States
(12) Patent Application Publication
(10) Pub. No.: US 2004/0202772 A1
(43) Pub. Date: Oct. 14, 2004

(54) Method for preparing glucose polymer having ion-exchanging ability and composition containing the same

(75) Inventors: Isao Matsuda, Itami-Shi (JP); Toyohide Nishibata, Nishinomiya-Shi (JP); Takashi Ichihara, Ashiya-Shi (JP); Yuriko Fukushima, Tsukuba-Shi (JP); Kazuhiro Okuma, Sanda-Shi (JP)

Correspondence Address: SUGHRUE MION, PLLC, 2100 PENNSYLVANIA AVENUE, N.W., SUITE 800, WASHINGTON, DC, 20037, US

(73) Assignee: MATSUTANI CHEMICAL INDUSTRIES CO., LTD.

(21) Appl. No.: 10/820,774

(22) Filed: Apr. 9, 2004

(30) Foreign Application Priority Data
Apr. 10, 2003 (JP) 2003-106933

(51) Int. Cl. C08B 3/00; C08B 5/00

(52) U.S. Cl. 426/658; 536/58

(57) ABSTRACT

A method for the preparation of a glucose polymer having an ion-exchanging ability comprises the steps of drying a mixed aqueous solution containing a raw glucose polymer and a polyvalent carboxylic acid to thus form a uniform powdery mixture and then subjecting the powdery mixture to a heat treatment. The method of the present invention can ensure the achievement of a high reaction efficiency, is economically advantageous since it never requires the use of any expensive catalyst and does not require the use of any complicated step for the removal of impurities. The glucose polymer prepared by the method of the present invention is biodegradable and can be used in, for instance, various foods and/or builders.

### BACKGROUND OF THE INVENTION

The present invention relates to a method for the preparation of a glucose polymer carrying carboxyl groups and a composition, which contains the glucose polymer and accordingly has an ion-exchanging ability. This composition would acquire such an ion-exchanging ability due to the action of free-carboxyl groups of the polymer and it has low viscosity. Examples of such compositions include builders for detergents and calcium-supplementing (or calcium-enriched) foods containing calcium ions associated thereto.

There have conventionally been known some compounds and saccharide compounds having a sequestering ability in which carboxyl groups are utilized as a functional group. High molecular weight poly(carboxylic acids) such as those disclosed in Patent Document 1 specified later prepared by polymerizing or copolymerizing, for instance, acrylic acid and/or maleic acid through radical reactions have been well known as builders for detergents, but it has also been well known that they cannot easily be decomposed microbiologically. Alternatively, there has also been known a method (oxidation polymerization method) for preparing a polymer carrying carboxyl groups by polymerizing the keto-malonic acid obtained through catalytic oxidation using platinum (see, for instance, Patent Document 2 specified later), but the method suffers from such a problem that a large amount of the monomer remains unreacted or the efficiency of the polymerization reaction in this method is quite low and that this method requires the use of an expensive platinum-containing solid catalyst and this in turn makes the production cost high.

With respect to saccharide compounds having carboxyl groups, there have been known, for instance, α-glucopyranosyl compounds carrying carboxyl groups introduced into the same (see, for instance, Patent Document 3 listed below) and a method for introducing carboxyl groups into a polysaccharide by cleaving, through oxidation, the carbon-carbon bonds, which exist in monosaccharide units constituting the polysaccharide and to which the neighboring secondary alcohols are linked to thus form polysaccharide-poly(carboxylic acids) (see, for instance, Patent Document 4 and Non-Patent Documents 1 and 2). As oxidizing agents used in such cleaving reactions, there have been known, for instance, hypochlorous acid (see, for instance, Patent Document 5) and periodic acid (see, for instance, Patent Document 6), but it is necessary to regenerate periodic acid and this results in an increase of the production cost. Moreover, the polysaccharide-di-aldehydes generated during the regeneration as intermediates should further be oxidized through the use of other oxidizing agents such as a chlorate or a hypochlorite. The hypochlorite is a relatively cheap oxidizing agent, but if a known method is used, the yield achieved by the oxidation using the same is quite low and the oxidation reaction is accompanied by an insufficient oxidation reaction and further undesirable depolymerization. The known conversion method is disadvantageous from the viewpoint of production cost and environmental protection since the method requires the use of excess hypochlorous acid on the order of about three times the usual amount. The products prepared according to these methods are excellent in their sequestering ability, but they are still insufficient in the biodegradability.

In addition, there has also been known an esterification reaction through a nucleophilic substitution reaction, which makes use of an activated acylating agent such as a carboxylic acid anhydride and a carboxylic acid chloride (see, for instance, Non-Patent Document 3 listed below). Most of these esterification reactions require the use of a catalyst such as an acid, a base and/or an organic solvent. All of these reactions suffer from a problem in that they require the use of quite complicated operations because of their high complicatedness and the requirements for, for instance, the removal of the solvents.

There have also been known reports concerning esterification reaction products of sugars and organic acids (see, for instance, Patent Documents 7 and 8). Some of them relate to reaction products of saccharides with substances carrying acyl groups, which are indigestible and may be used as substitutes for fats and the remaining reports relate to esterification reaction products of saccharides, sugars and saturated fatty acids, in which these substances may be reacted with one another in a solution using a liquid hydrogen fluoride, which simultaneously serves as a catalyst and a solvent in this reaction system.

Alternatively, there has been developed a dry method in which reactants are not dissolved in a liquid such as water or an organic solvent, but directly heated. For instance, there have been reported dry reactions of starch or dextrin with anhydrides of dibasic acids such as anhydrides of succinic acid and maleic acid (see, for instance, Patent Document 9). In this technique, solid raw materials are simply admixed together and the resulting non-uniform powder mixture is subjected to a reaction by heating and the Document discloses that the reaction products are used as adhesives and thickening agents. This technique is similar to the present invention, but the former significantly differs, in the technical ideas, from the latter in that acid anhydrides are used, that the reactants are admixed together by simply mixing them in solid conditions, that the reaction system is a heterogeneous one and that the reaction products are not used in the applications, which require the use of the ion-exchanging ability of free carboxyl groups of the products.

Further, a method for preparing low-caloric dextrin (see, for instance, Patent Document 10 specified below) has also been reported and this method comprises the steps of dissolving and dispersing starch or dextrin in a mixture of citric acid and water, spray-drying the resulting solution or dispersion using a spray-drying device and further heating the spray-dried product at a temperature ranging from 140 to 220° C. under reduced pressure (preparation of polysaccharides; see, for instance, Patent Document 11). Thus, indigestible products, in which the indigestibility thereof is determined by the fact that they are inactive to the action of an amylose-hydrolyzing enzyme, are formed to enhance the digestion-resistant properties of the starch or dextrin and to thus prepare water-insoluble substances. In this case, it would be recognized that citric acid is not reacted with starch or dextrin while maintaining the carboxyl group thereof in its free state, but is simply used as a crosslinking agent. It is not an object of these methods to make the most use of the ion-exchanging ability of the free carboxyl groups of carboxylic acids. In both of these methods, carboxylic acids are used as simple acid catalysts.

As polysaccharides carrying, in the molecule, charges derived from carboxyl groups, there have been known, for instance, pectin and alginic acid, but they suffer from problems such that the aqueous solutions thereof have high viscosities and that if they are added to other substances, they greatly affect the physical properties thereof.

Patent Document 1: Japanese Un-Examined Patent Publication Hei 4-209644

Patent Document 2: Japanese Un-Examined Patent Publication Hei 7-41554

Patent Document 3: Japanese Un-Examined Patent Publication Sho 63-54390

Patent Document 4: Netherlands Patent Application No. 7,012,380

Patent Document 5: Japanese Un-Examined Patent Publication Sho 60-226502

Patent Document 6: Japanese Un-Examined Patent Publication Hei 4-233901

Patent Document 7: U.S. Pat. No. 4,959,466

Patent Document 8: Japanese Un-Examined Patent Publication Sho 63-165393

Patent Document 9: U.S. Pat. No. 3,732,207

Patent Document 10: Japanese Examined Patent Publication Sho 56-29512

Patent Document 11: U.S. Pat. No. 3,766,165

Non-Patent Document 1: Tenside Detergents, 1977, 14: 250-256

Non-Patent Document 2: Starch/Staerke, 1985, 37: 192-200

Non-Patent Document 3: Handbook of Starch Science, 1997, pp. 53-54,

Published by Asakura Publishing Company

### SUMMARY OF THE INVENTION

Accordingly, it is an object of the present invention to provide a method for the preparation of a glucose polymer, which can solve or eliminate a variety of disadvantages associated with the foregoing conventional techniques such that compounds carrying carboxyl groups are inferior in the biodegradability; that the reaction efficiency of such compounds is quite low; that the conventional techniques are disadvantageous from the economical standpoint since they require the use of expensive catalysts; that they require the use of complicated steps for the removal of impurities; that the applications of the resulting products per se are highly restricted because of their insufficient usual characteristic properties; and that they cannot be used in foods or in the most important applications.

It is another object of the present invention to provide a composition containing the foregoing glucose polymer.

More specifically, it is an object of the present invention to provide a method for the preparation of a glucose polymer, which is biodegradable and can be used in foods, which can ensure the achievement of a high reaction efficiency, which is economically advantageous since it never requires the use of any expensive catalyst and which does not require the use of any complicated step for the removal of impurities as well as a composition comprising the resulting glucose polymer.

The inventors of this invention have conducted various studies to solve the foregoing problems associated with the conventional techniques, have found that these problems can be solved by the use of a uniform powdery reaction system and have thus completed the present invention.

According to the present invention, there is provided a method for the preparation of a glucose polymer having an ion-exchanging ability, which comprises the steps of drying a mixed aqueous solution containing a raw glucose polymer and a polyvalent carboxylic acid to thus form a uniform powdery mixture and then subjecting the uniform powdery mixture to a heat treatment.

### BEST MODE FOR CARRYING OUT THE INVENTION

The raw glucose polymer used herein is not restricted to any particular one inasmuch as it is a polymer containing glucose moieties as a structural unit thereof, but it is preferably at least one member selected from the group consisting of conventional processed starch products, in particular, oxidized starch, starch hydrolyzates, hydrogenated starch hydrolyzates and digestion-resistant starch hydrolyzates. Particularly preferred raw glucose polymers are, for instance, hydrogenated starch hydrolyzates and digestion-resistant starch hydrolyzates. Hydrogenated starch hydrolyzates are preferably used herein, since they seldom get colored during the reaction and accordingly, the commercial value of the resulting glucose polymer is highly improved. It is also preferred to use digestion-resistant starch hydrolyzates, since they not only have effects of imparting an ion-exchanging ability to the products, but also can be used as dietary fibers and low-caloric foods.

The degree of polymerization of the raw glucose polymer may widely vary depending on the intended characteristic properties of the resulting glucose polymer, but the average degree of polymerization thereof preferably ranges from 4 to 123, more preferably 4 to 18 and most preferably 6 to 10, while taking into consideration such requirement that the polymer is admixed with a polyvalent carboxylic acid and then dried to give a powdery mixture. If using a raw glucose polymer whose average degree of polymerization is higher than the upper limit, the resulting product has a sufficiently high ion-exchanging ability, but it may generate substances insoluble in water, when dissolved in water and accordingly, the applications thereof may be limited to some extent. On the other hand, if using a raw glucose polymer whose average degree of polymerization is lower than the lower limit, it cannot be converted into a powdery product.

When starch is used as a raw glucose polymer, the kinds thereof are not restricted to specific ones and specific examples thereof include potato starch, sweet potato starch, cornstarch and tapioca starch, either of which may effectively be used herein as raw starch without any restriction.

The polyvalent carboxylic acid usable in the present invention should have at least two carboxyl groups as functional groups in the molecule. Specific examples thereof are citric acid, malic acid, succinic acid, fumaric acid, malonic acid, maleic acid, adipic acid and tartaric acid. Among them, citric acid is most preferred carboxylic acid since it is a trivalent and cheaper carboxylic acid.

In the method of the present invention, a raw glucose polymer and at least one polyvalent carboxylic acid are first dissolved in water to form an aqueous solution.

The mixing ratio of the raw glucose polymer to the polyvalent carboxylic acid may appropriately be selected while taking into consideration the intended characteristic properties to be imparted to the resulting glucose polymer, but the ratio preferably ranges from 10:1 to 1.5:1 and more preferably 2:1 to 1.5:1 from such standpoints that the polyvalent carboxylic acid should be linked to the raw glucose polymer in an amount sufficient for imparting a satisfactory ion-exchanging ability to the final polymer product and that a uniform powdery mixture should be prepared.

In addition, the amounts of the raw glucose polymer and the polyvalent carboxylic acid to be dissolved in water are not restricted to specific ranges insofar as these substances ensure the formation of an aqueous solution, but it is common that the total amount of the raw glucose polymer and the polyvalent carboxylic acid preferably ranges from 20 to 50 parts by mass and more preferably 30 to 40 parts by mass per 100 parts by mass of water. These substances are usually dissolved in water under ordinary pressure and at a temperature ranging from 10 to 60° C., usually at ordinary temperature, if necessary, with stirring.

The resulting aqueous solution is dried at a temperature preferably ranging from 95 to 110° C. for 1 to 10 hours to thus give uniform powder or in general uniform amorphous powder. The resulting product in its powdery state can be subjected to a heat-treatment preferably carried out at a temperature ranging from 100 to 160° C. for 2 to 15 hours to thus obtain an intended glucose polymer having an ion-exchanging ability.

Examples of drying and powdering methods for obtaining uniform powder from a mixed aqueous solution of a raw glucose polymer and a polyvalent carboxylic acid include spray drying, drum drying and freeze drying methods and either of these methods may effectively be employed in the method of the invention.

When adopting a spray drying method using a spray dryer by way of an example of such drying method, uniform spherical powder may be prepared under the following spray conditions: a hot air temperature of 160° C.; an exhaust air temperature of 95° C.; and an atomizer's rotational frequency of 12,000 rpm.

Then the uniform powder thus prepared and comprising the raw glucose polymer and the polyvalent carboxylic acid is subjected to a heat-treatment. In this respect, a variety of the usual devices can be employed as heating means used in this step. Examples thereof effectively used herein are those permitting continuous heating such as an oil bath and a rotary kiln and specific examples thereof include a vacuum roasting device, an extruder, a drum dryer and a fluidized bed-heating device.

The temperature of the powder upon the heat-treatment according to the present invention preferably set at a level ranging from 100 to 160° C. and more preferably 100 to 125° C. In this connection, the higher the reaction temperature, the higher the rate of the reaction. However, if the reaction temperature is higher than 125° C., the reaction rate is high, but water-insoluble substances may sometimes formed as has been described above. Such water-insoluble substances are never formed under the temperature condition specified above, in particular, at a temperature ranging from 100 to 125° C. Moreover, the raw glucose polymer is exclusively linked to the polyvalent carboxylic acid through monoester bonds and the resulting product is accordingly almost free of any diester bond. Further, it has been made clear that the reaction product includes a large number of free carboxyl groups and that the product has an improved higher ion-exchanging ability.

The time for the heat-treatment is not particularly restricted and it is appropriately selected while taking into consideration a variety of factors such as the average degree of polymerization of the raw glucose polymer used, the mixing ratio of the polymer to the polyvalent carboxylic acid, the temperature of the reactants during the heat-treatment and the desired characteristic properties to be imparted to the intended final product, but it in general ranges from 1 to 20 hours and preferably 2 to 10 hours.

The purification of the product obtained in the reaction by heating may be omitted depending on the applications thereof, but when using the same, in particular, in foods or the like, the product may effectively be purified by the usual methods and devices used for the purification of the saccharides, for instance, a filtering device, desalting through the use of an ion-exchange resin and/or a membrane separator.

Evaluation of Product

The ion-exchanging ability of the glucose polymer as the product obtained in the reaction by heating according to the method of the present invention can be evaluated by the method detailed below.

[Amount of Polyvalent Carboxylic Acid Linked to Product]

The quantity of the ester bonds present in the glucose polymer prepared by the reaction, by heating, of a raw glucose polymer with a polyvalent carboxylic acid is determined using the high performance liquid chromatography (hereunder referred to as “HPLC”) to thus evaluate the reaction efficiency of the heat reaction between the raw glucose polymer and the polyvalent carboxylic acid. The quantitation method will be detailed below.

HPLC Device: Model LC8020 available from Tosoh Corporation;

Conditions for HPLC: Column used: Shodex Rspak KC-811 (available from Showa Denko, K.K.); Buffer Solution (Mobile Phase): 15 mM HClO₄ (pH 2.0); Flow Rate: 0.5 mL/min; Column Temperature: 60° C.; Detector: UV (215 nm). The internal standard used for the quantitative analysis was acetic acid anhydride.

The term “the amount of linked polyvalent carboxylic acid” herein used means a value obtained by quantitatively determining “the molar number of un-linked polyvalent carboxylic acid” on the basis of the data as determined by chromatography using UV detection and by subtracting “the molar number of un-linked polyvalent carboxylic acid present in the product obtained in the reaction by heating” from “the molar number of un-linked polyvalent carboxylic acid present in the uniformized powder prior to the heat treatment” (in other words, the overall molar number of the polyvalent carboxylic acid present in the sample) and the value is expressed in terms of the molar number of linked polyvalent carboxylic acid per mole of the anhydrous glucose unit as the structural unit of the raw glucose polymer.

[Esterification Index]

It is quite important to discriminate the mode of linkage or to discriminate whether the raw glucose polymer and the polyvalent carboxylic acid are linked through monoester bonds or diester bonds, in the evaluation of the ion-exchanging ability of the reaction product.

First, the glucose polymer is subjected to the neutralization titration to thus determine the total molar number C, that is, the sum of the molar number of carboxyl groups of un-linked polyvalent carboxylic acid and that of free carboxyl groups present on the linked polyvalent carboxylic acid (or the molar number of carboxyl groups except for those linked to the glucose polymer). Then the molar number of un-linked polyvalent carboxylic acid as determined by HPLC is multiplied by the carboxyl value (this is equal to 3 in case of citric acid) of the polyvalent carboxylic acid to thus determine the molar number D of carboxyl groups present on the un-linked polyvalent carboxylic acid. Finally, the molar number D is subtracted from the total molar number C to thus determine the molar number of free carboxyl groups present on the linked polyvalent carboxylic acid. This is expressed in terms of the number of free carboxyl groups per mole of the linked polyvalent carboxylic acid and defined to be an esterification index. For instance, in case of citric acid as a tri-carboxylic acid, the esterification index thereof is 2.0 when all of the ester bonds consist of monoester bonds, while it is 1.0 when all of the ester bonds consist of diester bonds. In this connection, the rate of monoesters is reduced and that of diesters increases as the esterification index is reduced from 2.0 and closer to 1.0. In case of dicarboxylic acid, the esterification index is equal to 1.0 when all of the ester bonds consist of monoester bonds.

[Index of Ion-Exchanging Ability]

This ion-exchanging ability index is determined on the basis of the amount of the linked polyvalent carboxylic acid (hereunder referred to as A) and the esterification index (hereunder referred to as B) specified above. If the ion-exchanging ability index is assumed to be Y, the following relation holds true: Y=AB. This relation corresponds to the molar number of free carboxyl groups per mole of the anhydrous glucose unit.

The present invention will hereunder be described in more detail with reference to the following Examples, but the present invention is not restricted to these specific Examples at all.

### EXAMPLE 1

There was dissolved, in 7 kg of water, 2.4 kg of “PINEDEX #2” (the trade name of a starch hydrolyzate having an average degree of polymerization of 10, available from Matsutani Chemical Industries, Co. Ltd.) as a raw glucose polymer with stirring and subsequently 0.6 kg of citric acid (available from Archer Daniels Midland Company in the United States) as a polyvalent carboxylic acid was dissolved therein (glucose units/citric acid (molar ratio)=4.75/1). Then the resulting aqueous solution was spray-dried using a spray dryer to give uniform raw glucose polymer/citric acid powder. Thereafter, 1.5 kg of the powder was heat-treated over 400 minutes while maintaining the temperature of the powder at 120° C. The product thus obtained was found to have an ion-exchanging ability index of 0.26 and an esterification index of 2.0 and when it was dissolved in water, any insoluble matter was not generated at all in the solution. The results thus obtained are listed in the following Table 1.

### EXAMPLE 2

The same procedures used in Example 1 were repeated under the same conditions used therein except that the temperature of the powder during the reaction by heating was changed to 90, 100, 110, 135, 160 and 170° C. and that the heating time was changed as specified below to thus conduct the reaction.

As a result, it was found that the esterification reaction never proceeded at all at a heating temperature of 90° C.

On the other hand, there were produced a glucose polymer having an ion-exchanging index of 0.12 and an esterification index of 2.0 at 100° C. for a heating time of 900 minutes and a glucose polymer having an ion-exchanging index of 0.20 and an esterification index of 2.0 at 110° C. for a heating time of 900 minutes.

There were likewise produced a glucose polymer having an ion-exchanging index of 0.29 and an esterification index of 0.19 at 135° C. for a heating time of 300 minutes and a glucose polymer having an ion-exchanging index of 0.34 and an esterification index of 1.6 at 160° C. for a heating time of 120 minutes.

In addition, at a powder-heating temperature of 170° C., the reactants were molten through heating and they could not maintain their powdery states.

The glucose polymers prepared at 135 and 160° C. generated insoluble matter when they were dissolved in water, while those prepared at 100 and 110° C. never generated insoluble matter when dissolved in water. These results are summarized in the following Table 1.

TABLE 1
Effect of Powder Temperature

| Temp. | Heating | Ion-Exch. | | |
|---|---|---|---|---|
| Of | Time | Ability | Esterification | |
| Powder | (min) | Index | Index | Remarks |
| 90° C. | 900 | 0 | 0 | The esterification reaction |
| | | | | did not proceed. |
| 100° C. | 900 | 0.12 | 2.0 | There was not observed |
| | | | | any water-insoluble |
| | | | | matter. |
| 110° C. | 900 | 0.20 | 2.0 | There was not observed |
| | | | | any water-insoluble |
| | | | | matter. |
| 120° C. | 400 | 0.26 | 2.0 | There was not observed |
| | | | | any water-insoluble |
| | | | | matter. |
| 135° C. | 300 | 0.29 | 1.9 | There was observed |
| | | | | generation of water- |
| | | | | insoluble matter. |
| 160° C. | 120 | 0.34 | 1.6 | There was observed |
| | | | | generation of water- |
| | | | | insoluble matter. |
| 170° C. | — | — | — | The reactants were molten |
| | | | | and could not hold their |
| | | | | powdery states. |

### EXAMPLE 3

“PINEDEX #2” as a raw glucose polymer and citric acid as a polyvalent carboxylic acid were dissolved in water with stirring at a mixing ratio of 10.5/1, 9/1, 4.75/1, 2/1, 1.5/1 and 1.33/1 (molar ratio) and then each resulting solution was spray-dried using a spray dryer to thus give uniform and amorphous powder. As a result, it was found that uniform powdery products were obtained at mixing ratios of 10.5/1, 9/1, 4.75/1, 2/1 and 1.5/1 (molar ratio), but any appropriate powder product was not obtained at a mixing ratio of 1.33/1 (molar ratio). Each resulting powdery product was then heat-treated. The heat-treatment was carried out under the same conditions used in Example 1 except that the mixing ratio was changed and that the heating reaction times were all set at 400 minutes. As a result, it was found that the reaction did not proceed so much at a mixing ratio of 10.5/1 and provided a glucose polymer having an ion-exchanging index of 0.08 and an esterification index of 2.0; that the reaction at a mixing ratio of 9/1 provided a glucose polymer having an ion-exchanging index of 0.12 and an esterification index of 2.0; that the reaction at a mixing ratio of 4.75/1 provided a glucose polymer having an ion-exchanging index of 0.26 and an esterification index of 2.0; that the reaction at a mixing ratio of 2/1 provided a glucose polymer having an ion-exchanging index of 0.44 and an esterification index of 2.0; and that the reaction at a mixing ratio of 1.5/1 provided a glucose polymer having an ion-exchanging index of 0.5 and an esterification index of 2.0. These results are summarized in the following Table 2.

TABLE 2
Effect of Mixing Ratio (Molar Ratio) of Raw Glucose Polymer to
Polyvalent Carboxylic Acid (120° C., PINEDEX #2, Citric Acid)

| | Ion-Exch. | | |
|---|---|---|---|
| Mixing | Ability | Esterification | |
| Ratio | Index | Index | Remarks |
| 10.5:1 | 0.08 | 2.0 | There was not observed any |
| | | | water-insoluble matter. |
| 9:1 | 0.12 | 2.0 | There was not observed any |
| | | | water-insoluble matter. |
| 4.75:1 | 0.26 | 2.0 | There was not observed any |
| | | | water-insoluble matter. |
| 2:1 | 0.44 | 2.0 | There was not observed any |
| | | | water-insoluble matter. |
| 1.5:1 | 0.50 | 2.0 | There was not observed any |
| | | | water-insoluble matter. |
| 1.33:1 | 0.34 | 1.6 | Any uniform powder could not |
| | | | be obtained. |

### EXAMPLE 4

Reactions were conducted under the same conditions used in Example 1 except for using “STABILOSE S-10” (the trade name of an oxidized starch having an average degree of polymerization of 123, available from Matsutani Chemical Industries, Co. Ltd.), “PINEDEX #100” (the trade name of a starch hydrolyzate having an average degree of polymerization of 18, available from Matsutani Chemical Industries, Co. Ltd.), “PINEDEX #2” (the trade name of a starch hydrolyzate having an average degree of polymerization of 10, available from Matsutani Chemical Industries, Co. Ltd.), “GLISTAR” (the trade name of a starch hydrolyzate having an average degree of polymerization of 6, available from Matsutani Chemical Industries, Co. Ltd.), “PINEDEX #3” (the trade name of a starch hydrolyzate having an average degree of polymerization of 4, available from Matsutani Chemical Industries, Co. Ltd.) and “Product 1 made on an experimental basis” (average degree of polymerization of 3; a starch hydrolyzate obtained by further hydrolyzing PINEDEX #3; hereunder simply referred to as “Product 1”).

Consequently, when using “STABILOSE S-10” as a raw glucose polymer, uniform powder could be obtained, but the powder generated water-insoluble matter in the subsequent heat-treating experiment. The raw glucose polymer “PINEDEX #100” provided a glucose polymer having an ion-exchanging ability index of 0.19 and an esterification index of 1.9, the raw glucose polymer “PINEDEX #2” provided a glucose polymer having an ion-exchanging ability index of 0.26 and an esterification index of 2.0, the raw glucose polymer “GLISTAR” provided a glucose polymer having an ion-exchanging ability index of 0.22 and an esterification index of 2.0 and the raw glucose polymer “PINEDEX #3” provided a glucose polymer having an ion-exchanging ability index of 0.20 and an esterification index of 2.0. In addition, “Product 1” did not provide any uniform powdery mixture with citric acid. The foregoing results are summarized in the following Table 3.

TABLE 3
Effect of Average Degree of Polymerization (ADP) of
Raw Glucose Polymer (Citric Acid; 120° C.)

| Av. | | Ion-Exch. | | |
|---|---|---|---|---|
| Mol. | | Ability | Esterification | |
| Wt. | ADP | Index | Index | Remarks |
| 20000 | 123 | — | — | There was observed generation |
| | | | | of water-insoluble matter. |
| 3000 | 18 | 0.19 | 1.9 | There was not observed any |
| | | | | water-insoluble matter. |
| 1600 | 10 | 0.26 | 2.0 | There was not observed any |
| | | | | water-insoluble matter. |
| 1000 | 6 | 0.22 | 2.0 | There was not observed any |
| | | | | water-insoluble matter. |
| 700 | 4 | 0.20 | 2.0 | There was not observed any |
| | | | | water-insoluble matter. |
| 600 | 3 | — | — | Any uniform powder could not |
| | | | | be obtained. |

### COMPARATIVE EXAMPLE 1

The method of the present invention is characterized in that a raw glucose polymer and a polyvalent carboxylic acid are once converted into a mixed aqueous solution, the aqueous solution is subsequently dried to give uniform powder and then the resulting uniform powder is heat-treated. Thus, the results of reactions observed when practicing the method of the present invention were compared with those observed when heating a simple mixed powder of a raw glucose polymer and a polyvalent carboxylic acid.

The ingredients used in this Comparative Example 1 were reacted under the same conditions used in Example 1 except for using “Product 2 made on an experimental basis” (hereunder referred to as “Product 2”) (a membrane-fractioned product of TK-16 (trade name of a starch hydrolyzate available from Matsutani Chemical Industries, Co. Ltd.); average degree of polymerization of 10) as a raw glucose polymer. As a result, it was found that uniform powder provided a glucose polymer having an ion-exchanging ability index of 0.26 and an esterification index of 2.0, while the presence of any linkage between the polyvalent carboxylic acid and the raw glucose polymer was not confirmed at all for the simple mixed powder as a comparative sample.

This result clearly indicates that the uniform powder of the present invention is highly reactive.

### COMPARATIVE EXAMPLE 2

The heat-treatment was conducted under the same conditions used in Example 1 except for using “Product 2” and “FIBERSOL-2” (the trade name of a digestion-resistant starch hydrolyzate having an average degree of polymerization of 10, which is a starch hydrolyzate scarcely hydrolyzed by any human digestive enzyme and it is admitted as water-soluble dietary fibers; available from Matsutani Chemical Industries, Co. Ltd.). The viscosity of the resulting heat reaction product was compared with those for sodium alginate and pectin and as a result, it was found that the product of the present invention had a low viscosity value even at a low temperature and that the viscosity thereof was almost independent of the temperature conditions. These results are summarized in the following Table 4.

TABLE 4

Viscosity (mPa · s)

| Temperature (° C.) | 20 | 70 |
|---|---|---|
| Heat reaction product derived from | 4.4 | 2.9 |
| Product 1 (10% W/V) | | |
| Heat reaction product derived from | 4.2 | 2.6 |
| FIBERSOL-2 (10% W/V) | | |
| Sodium alginate (1% W/V) | 169.2 | 45.8 |
| Pectin (1% W/V) | 11.9 | 5.2 |

### EXAMPLE 5

The same procedures used in Example 1 were repeated except that malic acid or succinic acid was used as a polyvalent carboxylic acid, that the mixing ratio of the polyvalent carboxylic acid to “PINEDEX #2” as a raw glucose polymer was selected such that the ratio: glucose unit/polyvalent carboxylic acid was equal to 4.75/1 (molar ratio) and that the heating time was changed to thus prepare desired glucose polymers.

As a result, there were prepared a glucose polymer having an ion-exchanging ability index of 0.11 and an esterification index of 1.0 (this indicates that only monoester bonds are present) when using succinic acid as a polyvalent carboxylic acid and a heating time of 300 minutes and a glucose polymer having an ion-exchanging ability index of 0.14 and an esterification index of 1.0 (this indicates that only monoester bonds are present) when using malic acid as a polyvalent carboxylic acid and a heating time of 300 minutes, respectively. The results obtained are listed in the following Table 5.

### EXAMPLE 6

The same procedures used in Example 1 were repeated except that two kinds of polyvalent carboxylic acid or malic acid and succinic acid were used, that the mixing ratio of the polyvalent carboxylic acids to “PINEDEX #2” as a raw glucose polymer was selected such that the ratio: glucose unit/malic acid/succinic acid was equal to 4.75/0.5/0.5 (molar ratio) and that the heating time was changed to thus prepare desired glucose polymers.

As a result, it was found that the glucose polymer obtained when setting the heating time at 300 minutes had an ion-exchanging ability index of 0.13 and an esterification index of 1.0 (this indicates that only monoester bonds are present). The results obtained are listed in the following Table 5.

TABLE 5
Effect of Kinds of Polyvalent Carboxylic Acids Used (120° C.,
PINEDEX #2, average degree of polymerization of 10)

| Polyvalent | Ion-Exch. | | |
|---|---|---|---|
| Carboxylic | Ability | Esterification | |
| Acid | Index | Index | Remarks |
| Citric acid | 0.26 | 2.0 | There was not observed any |
| | | | water-insoluble matter. |
| Malic acid | 0.14 | 1.0 | There was not observed any |
| | | | water-insoluble matter. |
| Succinic acid | 0.11 | 1.0 | There was not observed any |
| | | | water-insoluble matter. |
| Malic acid + | 0.13 | 1.0 | There was not observed any |
| Succinic acid* | | | water-insoluble matter. |

*The molar ratio of the mixture of these two acids was identical to that of each single acid.

### EXAMPLE 7

The same procedures used in Example 1 were repeated except for using “Product 3 made on an experimental basis” (a membrane-fractioned product derived from “H-PDX” (the trade name of a hydrogenated starch hydrolyzate available from Matsutani Chemical Industries, Co. Ltd.); average degree of polymerization of 10; hereunder simply referred to as “Product 3”) as a raw glucose polymer and changing the heating time to thus obtain a desired glucose polymer. As a result, the resulting glucose polymer was found to have an ion-exchanging ability index of 0.28 and an esterification index of 2.0 for a heating time of 350 minutes. The reaction product obtained from “Product 3” as a hydrogenated starch hydrolyzate was found to be almost free of coloration due to the reaction by heating.

### EXAMPLE 8

The same procedures used in Example 1 were repeated except for using “FIBERSOL-2” as a raw glucose polymer and changing the heating time to thus obtain a desired glucose polymer. As a result, the resulting glucose polymer was found to have an ion-exchanging ability index of 0.28 and an esterification index of 2.0 for a heating time of 350 minutes.

### EXAMPLE 9

### Determination of Re-Staining-Inhibitory Ability

A detergent comprises an additive called builder. The builder is a re-staining-inhibitory agent for preventing any re-staining of the wash or re-adhesion of once released stain onto the wash and it improves the cleaning effect of the surfactant included in the detergent. As a builder presently most frequently used, there may be listed sodium carboxymethyl cellulose (hereunder referred to as “CMC-Na”). This builder forms an anion when dissolved in water and the anions cover the surface of the wash from which stains have been removed in the form of a thin membrane-like layer and also cover the surface of the stain particles removed from the wash. Consequently, both of the fiber surface and the stain particles are negatively charged, they accordingly repulse each other and as a result, the wash is protected from any re-staining. However, CMC-Na is quite expensive and it is further said that the builder may cause pollution of water like zeolite.

The re-staining-inhibitory ability of the glucose polymer according to the present invention was evaluated by the determination of its manganese dioxide-dispersing ability. As sample materials, there were used “the heat reaction product derived from Product 2” and “the heat reaction product derived from FIBERSOL-2”, while CMC-Na was used as a control. Briefly, the method used herein comprised the steps of dispensing 1.0 g of manganese dioxide and 50 mL of a 0.05% aqueous solution of a sample builder in a 50 mL volume, graduated test tube with ground glass stopper, shaking the test tube up and down over 100 times and then allowing to stand for 4 hours in a thermostatic chamber maintained at 25° C. Then a volumetric pipette was fixed at a position 5 cm below the surface of water, 15 mL of the sample liquid was collected and the amount of manganese dioxide present in the suspension was determined with an oxidation-reduction titration method using Fe(SO₄)₂.(NH₄)₂—KMnO₄ titration system.

The results thus obtained are summarized in the following Table 6. As a result, it was confirmed that both of “the heat reaction product derived from Product 2” and “the heat reaction product derived from FIBERSOL-2” were excellent in re-staining-inhibitory ability since they were found to have re-staining-inhibitory abilities higher than that observed for CMC-Na. At this stage, regarding the relation between the manganese dioxide-dispersing ability and the detergency, it has already been reported that the higher the dispersion power, the higher the detergency. In other words, the foregoing results clearly indicate that these heat reaction products can be used as re-staining-inhibitory agents superior to CMC-Na.

TABLE 6
Evaluation of Manganese Dioxide-Dispersing Ability

| | Manganese dioxide-dispersing ability |
|---|---|
| Material | (mg, MnO₂/100 ml (0.05% solution)) |
| Heat reaction product derived from | 65.2 |
| Product 2 | |
| Heat reaction product derived from | 110.0 |
| FIBERSOL-2 | |
| CMC-Na | 17.7 |

### EXAMPLE 10

### Determination of Ion-Exchanging Ability

A glucose polymer was prepared using “the heat reaction product derived from FIBERSOL-2” (hereunder referred to as “FS2/Cit”) and the ion-exchanging ability thereof was evaluated according to the following method. First, 100 mg of FS2/Cit was dissolved in 10 ml of water to give an aqueous solution and the solution was neutralized with sodium hydroxide to thus convert the carboxyl groups present on the FS2/Cit into sodium salt-form (the amount of the sodium hydroxide was 13.055 mM as expressed in terms of the quantity of sodium ions). The solution was introduced into a dialysis membrane (Spectra/Por CE, MWCO: 1000), the solution was thus dialyzed against a 65.275 mM calcium chloride aqueous solution as an external solution with stirring, while appropriately sampling the external solution, and the quantity of sodium ions present in the sample solution was determined using an atomic absorption spectrophotometer (AA-680 available from Shimadzu Corporation) to thus inspect the glucose polymer for the ion-exchanging ability between sodium and calcium ions. As a result, it was found that 79% of the theoretical carboxyl groups present on FS2/Cit were exchanged with calcium ions after the dialysis over 6 hours and this clearly indicates that the glucose polymer of the present invention possesses a satisfactory ion-exchanging ability.

Formulation 1 (Calcium-Enriched Beverage)

FS2/Cit was neutralized with calcium carbonate to thus convert the carboxyl groups present on the FS2/Cit into calcium salt-form (hereunder referred to as “FS2/Cit-Ca”). The FS2/Cit-Ca thus prepared was soluble in water (at least up to 50% (w/v)) and the resulting solution was free of any turbidity and a transparent liquid. When using it in a beverage, it never impaired the appearance of the beverage and never adversely affected the taste and quality thereof and it permitted the formulation of a calcium-enriched beverage (containing 90 mg of calcium per 100 ml of the beverage). The formulation thereof will be detailed in the following Table 7.

TABLE 7
Formulation of Calcium-Enriched Beverage (Amt. (g) per 100 ml)

| | |
|---|---|
| FS2/Cit-Ca | 3.92 |
| Granulated sugar | 7.00 |
| Citric acid | 0.35 |
| Mixed vitamin | 0.20 |
| Sodium chloride | 0.005 |
| Potassium chloride | 0.008 |
| Flavor | 0.10 |
| Water | Add water to 100 ml |

As has been described above in detail, the method of the present invention comprises the step of preparing a uniform powdery mixture of a raw glucose polymer and a polyvalent carboxylic acid prior to the reaction thereof and thus permits the solution of a variety of disadvantages associated with the conventional techniques for the preparation of polymers carrying carboxyl groups.

The method of the present invention can ensure the achievement of a high reaction efficiency, is economically advantageous since it never requires the use of any expensive catalyst and does not require the use of any complicated step for the removal of impurities.

The glucose polymer prepared by the method of the present invention is biodegradable and can be used in, for instance, various foods and/or builders.

What is claimed is:

1. A method for the preparation of a glucose polymer having an ion-exchanging ability comprising the steps of drying a mixed aqueous solution containing a raw glucose polymer and a polyvalent carboxylic acid to thus form a uniform powdery mixture and then subjecting the powdery mixture to a heat treatment.

2. The method for the preparation of a glucose polymer of claim 1, wherein the raw glucose polymer is at least one member selected from the group consisting of oxidized starch, starch hydrolyzates, hydrogenated starch hydrolyzates and digestion-resistant starch hydrolyzates and the average degree of polymerization thereof ranges from 4 to 123.

3. The method for the preparation of a glucose polymer of claim 1, wherein the raw glucose polymer is at least one member selected from the group consisting of oxidized starch, starch hydrolyzates, hydrogenated starch hydrolyzates and digestion-resistant starch hydrolyzates and the average degree of polymerization thereof ranges from 4 to 18.

4. The method for the preparation of a glucose polymer as set forth in any one of claims 1 to 3, wherein the polyvalent carboxylic acid is at least one member selected from the group consisting of citric acid, succinic acid, maleic acid, fumaric acid and tartaric acid.

5. The method for the preparation of a glucose polymer as set forth in any one of claims 1 to 4, wherein the glucose polymer has an ion-exchanging ability index as expressed by the function: Y=AB (Y represents an ion-exchanging ability index, A represents the amount of linked polyvalent carboxylic acid and B represents an esterification index) ranging from 0.1 to 0.5.

6. The method for the preparation of a glucose polymer as set forth in any one of claims 1 to 5, wherein the temperature of the powder upon the heat-treatment ranges from 100 to 160° C.

7. The method for the preparation of a glucose polymer as set forth in any one of claims 1 to 5, wherein the temperature of the powder upon the heat-treatment ranges from 100 to 125° C.

8. The method for the preparation of a glucose polymer as set forth in any one of claims 1 to 7, wherein the mixing ratio (molar ratio) of the raw glucose polymer to the polyvalent carboxylic acid ranges from 1.5:1 to 9:1.

9. A composition comprising a glucose polymer prepared according to the method as set forth in any one of claims 1 to 8 and having an ion-exchanging ability.

10. A builder comprising a glucose polymer prepared according to the method as set forth in any one of claims 1 to 8.

11. A detergent comprising a builder as set forth in claim 10.

12. A food comprising a glucose polymer prepared according to the method as set forth in any one of claims 1 to 8.

13. A food comprising a glucose polymer prepared according to the method as set forth in any one of claims 1 to 8, in the calcium-ion-exchanged form.
